(19) United States
(12) Patent Application Publication
(10) Pub. No.: US 2009/0080565 A1
(43) Pub. Date: Mar. 26, 2009

(54) PULSE SHAPING FOR EGPRS-2

(75) Inventors: Marian Rudolf, Montreal (CA); Behrouz Aghili, Melville, NY (US); Stephen G. Dick, Nesconset, NY (US); Prabhakar R. Chitrapu, Blue Bell, PA (US); Yan Li, Center Valley, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/186,657

(22) Filed: Aug. 6, 2008

Related U.S. Application Data
(60) Provisional application No. 60/954,197, filed on Aug. 6, 2007.

(51) Int. Cl. H04L 27/00

(52) U.S. Cl. 375/295

(57) ABSTRACT

A method and apparatus are disclosed for wireless transmission using two or more pulse shaping filters. Wireless transmit/receive units (WTRUs) and network entities are capable of utilizing a narrow band pulse shaping filter, a wideband pulse shaping filter, or both. The network entity and/or the WTRU select a pulse shaping filter to be used and transmits the selection by means of signaling. The signaling may be performed through layer 2/3 messages or by using non-access stratum (NAS) signaling messages.

### CROSS REFERENCE TO RELATED APPLICATIONS

This application claims the benefit of U.S. provisional application No. 60/954,197, filed Aug. 6, 2007, which is incorporated by reference as if fully set forth.

### FIELD OF INVENTION

The present invention is related to wireless communication systems.

### BACKGROUND

In the current design of Enhanced General Packet Radio Services (EGPRS), the transmission and reception of signals between a wireless transmit receive unit (WTRU) and a base station system (BSS) is done over basic frequency channels of 200 KHz width using a signaling symbol rate of 271 thousands symbols per second (kSps).

Global system for mobile communications (GSM) Release 7 (R7) introduces several features to improve upon throughput in the uplink (UL) and downlink (DL), as well as to reduce latency of transmissions. Among these, GSM R7 will introduce EGPRS-2 to improve upon throughput for the DL and the UL. EGPRS-2 throughput improvements in the DL are known as the Reduced Symbol Duration Higher Order Modulation and Turbo Coding (REDHOT) feature, and improvements for the UL are known as the Higher Uplink performance for GERAN Evolution (HUGE)feature. EGPRS-2 DL and REDHOT are synonymous.

In addition to legacy enhanced general packet radio service (EGPRS) modulation and coding schemes (MCS) based on Gaussian minimum shift keying (GMSK) (MCS-1 through MCS-4) and 8 phase-shift keying (8PSK) modulations (MCS-5 through MCS-9), REDHOT will use quadrature PSK (QPSK), 16 quadrature amplitude modulation (16QAM) and 32QAM modulations. Another technique for improved throughput is the use of Turbo coding (as opposed to Convolutional Coding with EGPRS). Furthermore, operation at higher symbol rate (HSR) than EGPRS is another improvement. With HSR transmission, bursts are transmitted at a proposed signaling rate of 325 kSps instead of the legacy transmission rate 271 kSps (hereafter referred to as Low or Legacy Symbol Rate (LSR)). HUGE is the corresponding uplink (UL) enhancement feature for GERAN, and similar to REDHOT.

A network and/or a wireless transmit/receive unit (WTRU), (i.e., a mobile station (MS)) supporting REDHOT and/or HUGE can implement either REDHOT Level A (RH-A) or REDHOT Level B (RH-B) and/or HUGE-A, HUGE-B and HUGE-C. While a WTRU implementing RH-B should achieve maximum throughput gain by using the full set of performance-improving features defined for REDHOT, a RH-A WTRU that implements a chosen subset of improvement techniques will still achieve a net improvement over legacy EGPRS. The RH-A solution will also be easier to implement than a full RH-B implementation.

Specifically, RH-A will implement eight (8) new MCSs, using 8PSK, 16QAM and 32QAM modulation. These are called downlink Level A MCS (DAS)-5 through DAS-12. RH-B, will implement another set of eight (8) new MCSs, based on QPSK, 16QAM and 32QAM modulations. These are called downlink Level B MCS (DBS)-5 through DBS-12. Unlike legacy EGPRS, both RH-A and RH-B use Turbo coding for the data portions of the radio block. For link adaptation purposes, both RH-A and RH-B WTRUs will reuse legacy EGPRS MCS-1 through MCS-4 (all based on GMSK modulation). In addition, RH-A will also re-use legacy EGPRS MCS-7 and MCS-8 for link adaptation. Further, RH-B will re-use legacy EGPRS MCS-8 and RH-A DAS-6, DAS-9 and DAS-11 for link adaptation. Therefore, an RH-A WTRU will support {MCS-1 through MCS-4, MCS-7 through MCS-8, and DAS-5 through DAS-12} and an RH-B WTRU will support {MCS-1 through MCS-4, MCS-8, DAS-6, DAS-9, DAS-11, and DBS-5 through DBS-12}. However, an RH-A WTRU will exclusively operate at legacy (low) EGPRS symbol rate (LSR), while RH-B WTRU can only operate at higher symbol rate (HSR). A RH-B WTRU is required to implement functionality according to RH-A and RH-B specifications.

There exist various levels of operation with REDHOT and/or HUGE where the WTRU and the network are allowed to operate at 20% higher symbol rate (325 kSps) and therefore 20% shorter symbol duration compared to the GSM legacy transmission rate, (i.e., 271 kSps). However, using higher than legacy symbol rate transmissions in GSM has immediate consequences on transmit pulse shaping design, interference created in-band (co-channel interference (CCI)) and on neighboring frequencies (adjacent channel interference (ACI)), receiver performance and also receiver equalizer complexity.

GSM radio equipment traditionally use a linearized Gaussian minimum shift keying (GMSK) 200 kHz pulse resulting in a narrow-band spectral mask to protect adjacent GSM channels (typically at multiples of +/−200 kHz), and a typical equalizer length of 5 symbols. FIG. 1 shows a spectral mask 101 resulting from the legacy linearized GMSK pulse 102.

It has been identified during early stages of the design process for REDHOT and/or HUGE that re-using the same legacy linearized GMSK pulse with higher symbol rate (HSR) transmissions results in extremely poor performance for REDHOT and/or HUGE because of partial response behavior of the transmissions (more inter-symbol correlation and interference). Also, higher back-off values in the transmit amplifier are needed due to increased peak-to-average ratios particularly with the 16- and 32-QAM modulations that are required for higher peak rates. Therefore, several wideband (compared to the legacy linearized GMSK pulse) alternatives to the legacy linearized GMSK pulse filter shaping were investigated. For example, root raised cosine (RRC) filters with a rolloff factor 0.3 at varying passband bandwidths 200 kHz, 240 kHz and 325 kHz were investigated. FIG. 2 shows the power density spectra of a legacy linearized GMSK pulse 201 compared to a wideband filter spectrum for RRC 0.3 with 325 kHz double sided bandwidth, shown as curve 202.

Due to the wideband pulses used, link performance for REDHOT/HUGE HSR transmission modes are improved. However, the wideband pulse negatively affects adjacent GSM channels (typically offset at multiples of +/−200 kHz), because of the much wider spectral width of the new pulse significantly increasing leakage of power (“interference”) into the adjacent channels.

While using a wideband filter for HSR transmissions significantly increases performance throughput- and coverage-wise for REDHOT and HUGE, it is detrimental to performance of WTRUs operating in adjacent GSM channels because of its much higher level of power leakage due to its wider spectral mask (see FIG. 2). The problem is aggravated more for legacy GSM equipment currently in use, which cannot be redesigned to take this changed interference into account for receiver design. However, even with the newly designed equipment, taking the presence of the new type of wideband pulse into account, the typical signal-to-interference ratio (SIR) experienced on adjacent channels would degrade so much, that entire frequency channels cannot be used anymore for REDHOT and/or HUGE transmissions as guard band—which completely negates the possible gains and obsoletes the use of the new type of wideband filter for HSR transmissions.

Another problem may occur when one or more of the channels assigned to a WTRU(s) in one operator's network happen to be adjacent, or too close to another operator's network. Under such a circumstance, special care must be taken when allowing the WTRU to use a wideband filter in order to make sure that the used energy does not leak into the adjacent channels. A similar, but somewhat different, situation can also be recognized when the operator does not have contiguous frequencies or blocks of frequencies.

Therefore, a method and apparatus is needed for implementing REDHOT and HUGE without the limitation of the prior art.

### SUMMARY

A method and apparatus are disclosed for wireless transmission using two or more pulse shaping filters. Wireless transmit/receive units (WTRUs) and network entities are capable of utilizing a narrow band pulse shaping filter, a wideband pulse shaping filter, or both. The network entity and/or the WTRU select a pulse shaping filter to be used and transmits the selection by means of signaling. The signaling may be performed through layer 2/3 messages or by using non-access stratum (NAS) signaling messages.

### BRIEF DESCRIPTION OF THE DRAWINGS

A more detailed understanding may be achieved from the following description, given by way of example in conjunction with the accompanying drawings wherein:

FIG. 1 shows a legacy linearized GMSK pulse spectrum and a GSM legacy spectral mask;

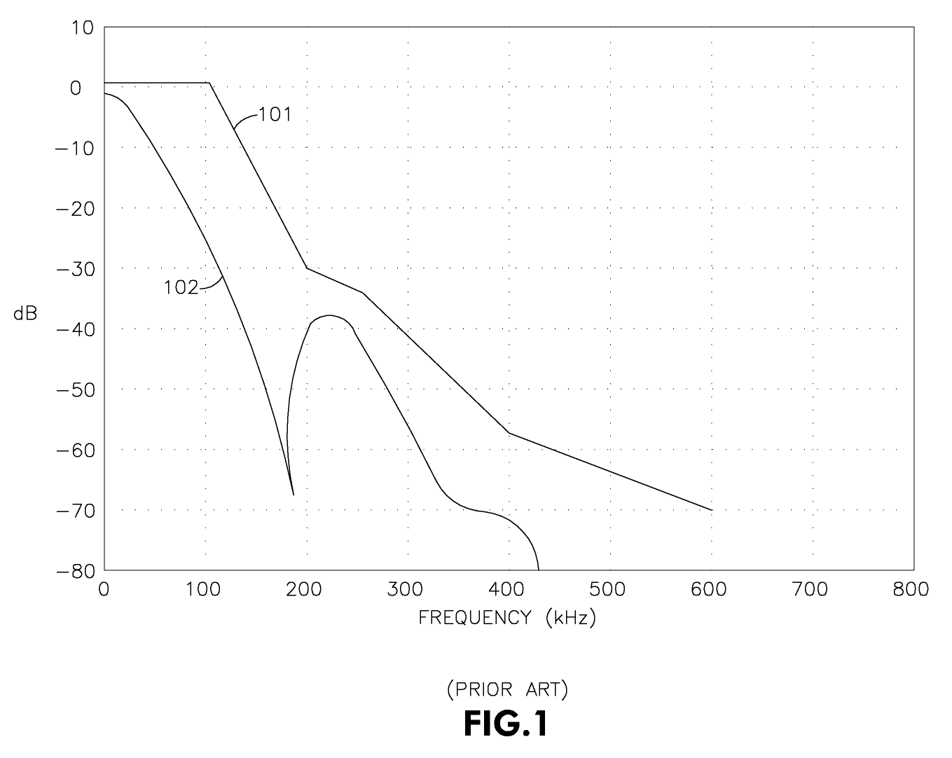

FIG. 2 shows a wideband filter spectrum for RRC 0.3 325 kHz compared to a legacy linearized GMSK pulse;

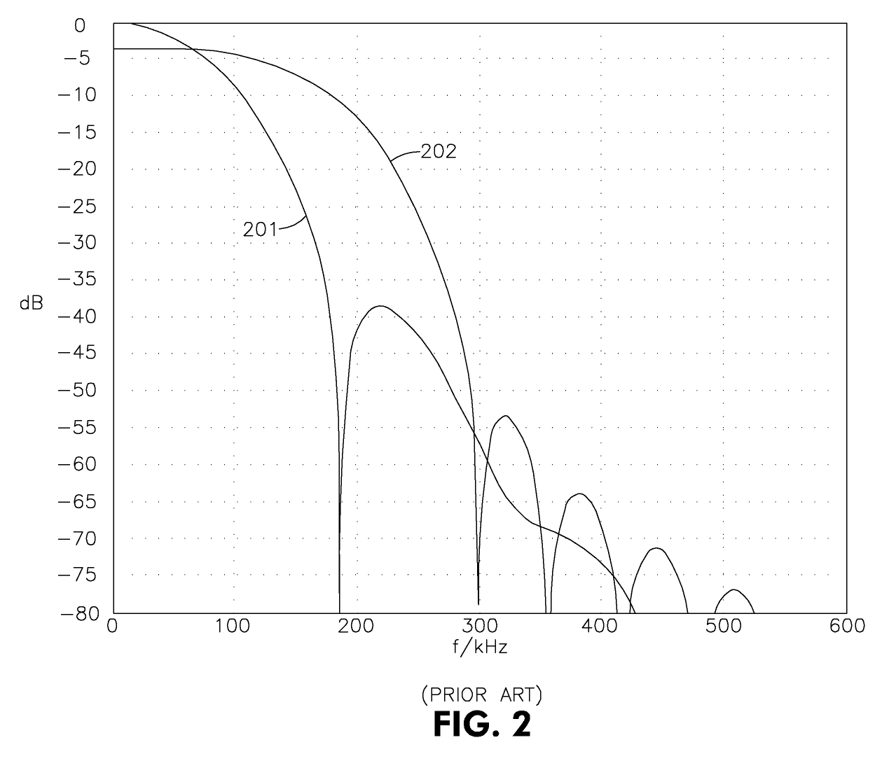

FIG. 3 shows an example wireless communication system;

FIG. 4 shows an example wireless transmit receive unit configured to implement a disclosed method of selecting pulse shape filter; and

FIG. 5 shows a flow diagram of the disclosed method for selecting an appropriate pulse shape.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

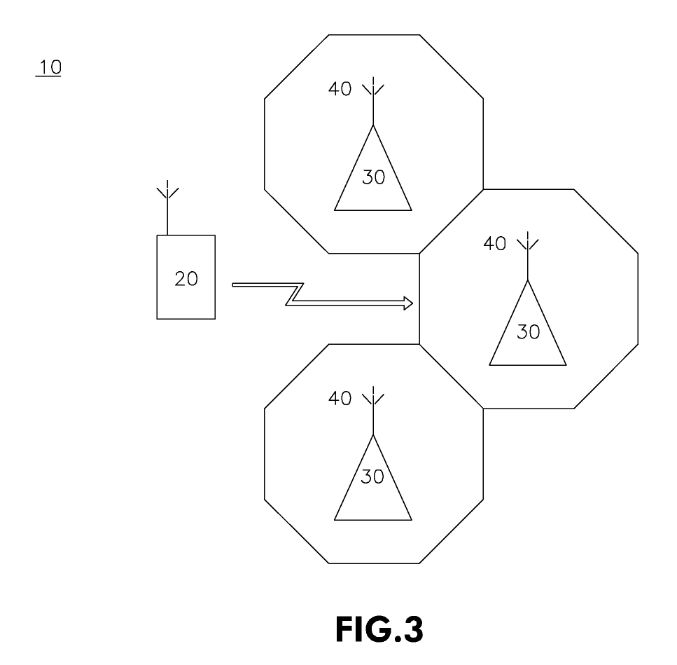

FIG. 3 shows an example wireless communication network (NW) 10 comprising a WTRU 20, one or more network equipment 30, e.g., Node Bs, and one or more cells 40. Each cell 40 comprises one or more Node Bs (NB or eNB) 30. WTRU 20 network equipment 30 are configured to implement the disclosed pulse shape selection method.

In accordance with the disclosed method and apparatus, WTRU 20 and a network equipment 30 may implement a narrow band pulse shaping filter, (i.e., the legacy linearized Gaussian Minimum Shift Keying (GMSK) pulse shaping filter), and a wideband pulse shaping filter, or only one of them.

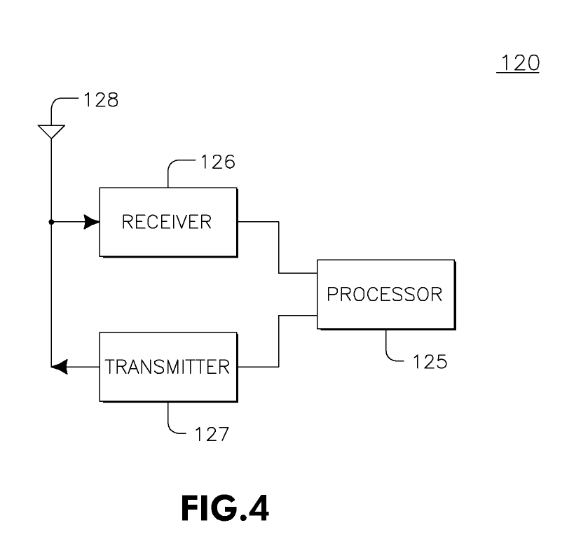

FIG. 4 is an example of a functional block diagram of a WTRU 20. In addition to components included in a typical transceiver, WTRU 20 includes a processor 125, configured to perform pulse shape selection, as disclosed below. Receiver 126 is in communication with processor 125, transmitter 127 in communication with processor 125, and antenna 128 in communication with receiver 126 and transmitter 127 to facilitate the transmission and reception of wireless data.

Transmitter 127 of WTRU 20 is configured to transmit a pulse capability signal that is preferably included in Layer 2 and Layer 3 (L2/L3) messages, such as those commands used by the radio link control/medium access control (RLC/MAC). The pulse capability signal may also be included in a non-access stratum (NAS) signaling message, (such as commonly used between a WTRU and a core network (CN) node, such as GPRS support node (GSN)). The pulse capability signal is used by WTRU 20 and/or network equipment 30 to exchange information about which specific pulse shaping filter or pulse is supported by WTRU 20 or network equipment 30.

As indicated, WTRU 20 transmits its implemented pulse filter types in capability messages or information elements (IEs) that are included in the above messages to a base station system (BSS) and/or GSN 30. For example, in order for WTRU 20 to signal its pulse shape implementation(s) and capabilities to network 10, the pulse type signal may be an extension or a modified version of a current IE, for example one of the following IEs:

(1) WTRU Classmark IE (can be of type 1, 2 or 3);

(2) WTRU Radio Access Capability IE, also referred to as MS RAC; or

(3) WTRU Network Capability IE, also referred to as MS NW Capability.

As such, WTRU 20 may transmit the pulse capability signal upon connecting to network 10, or when WTRU 20 registers with the network 10 or at some point during the communication process.

It should be noted that the pulse capability signal from WTRU 20 may include the specific type of pulse filter that it can support, or the number of pulse filter types it can support or the like. Also, a WTRU supported pulse filter type(s) may be implicitly signaled by association with one or more WTRU class(es) (e.g., REDHOT-B, HUGE-B or HUGE-C capable, therefore, able to implement both types, etc.), or sets of implemented capabilities. For example, if WTRU 20 supports HUGE-B, WTRU also supports the wideband filter. This can be a mandated rule as well, to be disclosed hereinafter.

WTRU 20 sends this capability information (“which pulse type(s) supported”) through capability messages exchanges, (e.g., the MS RAC IE snet in an attached request message), or following a Classmark Enquiry/Change. Because the factors influencing the choice of the wideband versus the legacy pulse typically are known in network 10, WTRU 20 may not freely select an appropriate filter. Accordingly, processor 125 of WTRU 20 may implement a rule that specifically mandates its choice of a transmission pulse type conditioned upon signaling received from network 10.

The rule in processor 125 may include a default rule. For example, the legacy pulse or the new pulse must be used unless signaling from the network specifically allows for this possibility. Another possible default rule is related to storing information about the network, the cell, the area, or combination thereof in processor 125 of WTRU 20, and evaluating this information during the system or network (re-)selection process. For example, if the stored information includes “network X, legacy pulse only”, then processor 125 of WTRU 20 implements a procedure that prevents the use of the wideband pulse for as long as WTRU 20 is associated with network X.

Another example default rule may exclude certain types of transmissions, e.g., certain RLC/MAC control blocks, from using the wideband pulse due to their system critical performance. Processor 125 of WTRU 20 therefore, may implement a rule that conditions the use of the legacy pulse on the specific nature of its transmission, e.g., when it intends to send a certain type of RLC/MAC control block in the uplink (UL), the logic in processor 125 forces WTRU 20 to use the legacy pulse irrespective of other configurations currently allowed or configured in WTRU 20.

In accordance with this disclosed method, network 10 implements a procedure(s) for determining if a specific pulse type can be used, or should be disallowed from use in certain frequencies, channels, timeslots, cells, sectors, or groups, defined coverage areas, and other conditions listed below. For example, base station 30, or a base station controller, evaluates radio conditions in network 10 either at start-up, at connection, occasionally, or after specific occurrences of events, to determine if there are conditions that would currently allow or disallow the use of the wideband pulse, or if the legacy pulse must be chosen for certain transmissions on certain frequencies, channels, cells, sectors, timeslots, or the like. The conditions may include:

(1) min, max, average, derived statistics of interference or power levels;

(2) as a function of current, announced or anticipated channel assignments;

(3) as a function of reported or indirectly derived measurements or quality metrics;

(4) output obtained by statistical modeling; or

(5) from an arbitrary combination of above.

The network node determining these factors may then forward and configure other network nodes. Either the same node or the other nodes may in turn configure the signal processing entities in the node and/or remotely configure WTRU 20 for its transmissions. Alternatively, the determination of the pulse type and signaling to WTRU 20 through protocol messages may occur in a combination of network nodes. For example, a base station controller may configure a base station to use a specific pulse type for downlink (DL) transmissions to a particular WTRU on a certain frequency or channel. Depending on the signaling message used, network equipment 30 may forward relevant WTRU information about the pulse types supported by WTRU 20 to other network nodes. For example, WTRU RAC information, including the pulse type new information, may be forwarded to the BSS to allow proper system operation for a specific WTRU.

A pulse selection indicator may be used by a GSM network node to inform a WTRU, a group of WTRUs, or configure one or more cells, sectors, parts or the entire coverage area, about the specific pulse form to be used or that is currently in use, or enforce the use of a specific pulse shape. The pulse selection indicator may specifically allow the use of the pulse form or pulse shape filter in the WTRU and/or the network equipment. When signaled for DL transmissions to provide WTRU 20 with information about which pulse form to expect from base station 30, the GSM signaling assists WTRU 20 in the process of decoding REDHOT transmissions. When signaled for UL transmissions, this signaling mandates the pulse form to be used by the WTRU, group of WTRUs or all WTRUs in an area for HUGE transmissions. The disclosed signaling comprises information regarding whether a certain pulse shape is allowed, disallowed, in use, or not in use for transmissions. This information may be related to the entire network, in one or more specific cells, or sectors, or any sub-division of the network; for a particular WTRU, a group of WTRUs or all WTRUs, not necessarily in the same cell; for time duration (specified amount of time, or transmission duration, . . . ); if subject to occurrence or absence of one or more described conditions, like max or min interference levels, signaling strength triggers, received signaling message; if valid, not valid, or free for certain frequencies and/or channels, or sets thereof; for specific timeslots, resource allocations, PDCHs; for resources allocated using Frequency Hopping parameters where use of the wide filter may be restricted on certain frequencies; if applicable to a DL transmission, or for UL transmission, or for both; subject to constraints like modulation and coding schemes used for initial or retransmissions; or arbitrary combinations of above.

In accordance with the disclosed method, WTRU 20 receives information in the pulse selection indicator including any one or more of which pulse types that can be used in the UL, which pulse types are used in the communication process in the DL, and the conditions of use surrounding a specific pulse type either for the DL, for the UL, or for both. This information may be distributed to WTRU 20 through the GSM/GPRS/EGPRS broadcast channels, (e.g., broadcast control channel (BCCH), (P)BCCH, etc.).

Network 10, as indicated above, transmits to WTRU 20 the allowed filter(s) to be used during the operation through any message used in GSM signaling, e.g., temporary block flow (TBF) allocations, re-allocations, handover commands, assignment messages, or the like. These messages are used by network 10 to indicate to one or more WTRUs the pulse type chosen or allowed for the DL transmission, which is used by the WTRU in the decoding process, or the pulse type for WTRU UL transmissions. It should be noted that the information about the DL and the UL is not required to be sent as part of the same message, and therefore may be sent and configured separately.

Messages that can be used include, but are not limited to, the initial TBF allocation messages. Network 10, though, has the ability to modify the sent pulse shape information in subsequent TBF related messages, e.g., those listed below, or by using RLC/MAC control blocks of type positive acknowledgement (ACK)/negative acknowledgement (NACK), (e.g., packet UL ACK/NACK). Examples of TBF related messages include, but are not limited to, PACKET DOWNLINK ASSIGNMENT, MULTIPLE TBF DOWNLINK ASSIGNMENT, PACKET UPLINK ASSIGNMENT, MULTIPLE TBF UPLINK ASSIGNMENT, PACKET TIMESLOT RECONFIGURE, MULTIPLE TBF TIMESLOT RECONFIGURE, or PACKET CS RELEASE INDICATION messages.

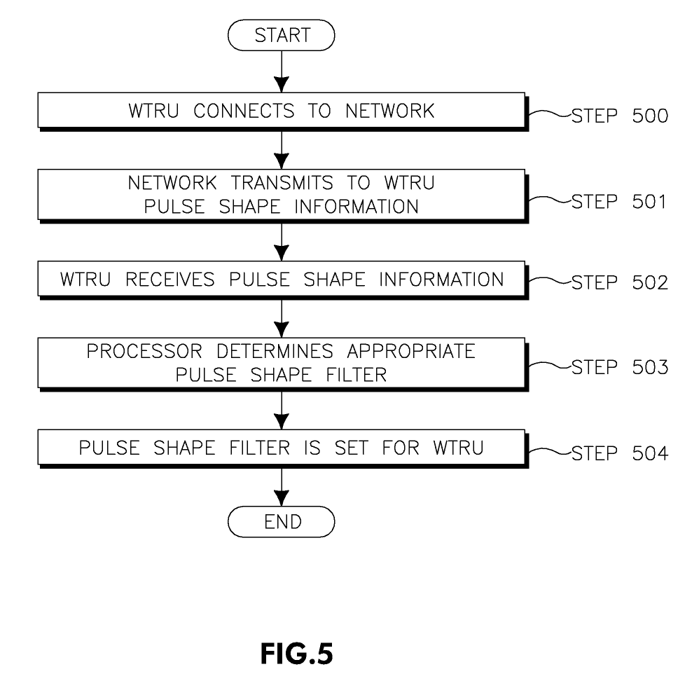

FIG. 5 shows a flow diagram of the disclosed method for selecting an appropriate pulse shape. WTRU 20 connects to network 10 (step 500). Network 10 transmits to WTRU 20 pulse shape information using the connected BSS 30 or any network equipment (step 501). WTRU 20 receives the pulse shape information (step 502) and processor 125 of WTRU 20 determines the appropriate pulse shape filter (step 503). Once processor 125 determines the appropriate pulse shape filter, the pulse shape filter is set for WTRU 20 accordingly (step 504).

It should be noted that although one wide band pulse has been discussed, more than one wide band pulse may be implemented in the network. As such, the WTRU would signal its capability regarding any pulse forms present in the network, and the appropriate pulse form or pulse shape filter will be selected as disclosed above.

In an alternative method, the pulse shape information can be signaled through bit or symbol fields in a radio burst or a radio block, or included in the RLC/MAC header portions of data blocks. As such, the network may signal allowed or disallowed pulse types for either one or more WTRUs, or for one or more timeslots, channels, or cells, sectors, or a combination thereof as part of the same transmission. For example, a special signaling frame or burst or block or RLC/MAC message would include this information.

In yet another alternative, the signaling by which the network sends information about the DL pulse type and/or UL pulse type, may be realized through GSN-to-WTRU signaling, such as new parts of or extensions of NAS signaling protocol messages.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method implemented in a wireless transmit receive unit (WTRU) comprising:
transmitting a pulse capability signal including an indication of a pulse form or pulse shape filter that is supported by the WTRU; and
receiving an assignment message, wherein the assignment message includes an indication of the pulse form or pulse shape filter to be used by the WTRU.

2. The method of claim 1, wherein the assignment message includes a pulse selection indicator for indicating the pulse form or pulse shape filter to be used by the WTRU.

3. The method of claim 2, wherein the pulse selection indicator is included in an information element.

4. The method of claim 3, wherein the assignment message includes the information element.

5. The method of claim 3, wherein the appropriate pulse form or pulse shape filter for use by the WTRU is implicitly indicated when the information element is not present in the assignment message.

6. The method of claim 1, further comprising selecting the pulse form or pulse shape filter based at least in part on the received assignment message.

7. The method of claim 6, wherein the selection is made in accordance with a defined WTRU rule.

8. The method of claim 1 wherein the signaling for the assignment message is performed through layer 2 or layer 3 messages.

9. The method of claim 1 wherein a signaling for the assignment message is performed using non-access stratum (NAS) signaling messages.

10. The method of claim 1, wherein the pulse capability indicator is transmitted upon connection to a network.

11. The method of claim 1, wherein the pulse capability indicator is transmitted upon registering with a network.

12. The method of claim 1, wherein the pulse capability indicator is transmitted while communicating in the network with a network equipment.

13. The method of claim 1, wherein the selected pulse form or pulse shape filter is selected based in part on the WTRU.

14. A wireless transmit receive unit (WTRU) comprising:
a transmitter for transmitting a pulse capability signal including an indication of a pulse form or pulse shape filter that is supported by the WTRU; and
receiving an assignment message, wherein the assignment message includes an indication of the pulse form or pulse shape filter to be used by the WTRU.

15. The WTRU of claim 14, wherein the assignment message includes a pulse selection indicator for indicating the pulse form or pulse shape filter to be used by the WTRU.

16. The WTRU of claim 15 further comprising a processor for determining the pulse form or pulse shape filter based on the pulse selection indicator.

17. The WTUR of claim 16, wherein the pulse selection indicator is included in an information element.

18. The WTRU of claim 17, wherein the assignment message includes the information element.

19. The WTRU of claim 17, wherein the appropriate pulse form or pulse shape filter for use by the WTRU is implicitly indicated when the information element is not present in the assignment message.

20. The WTRU of claim 16, wherein the processor selects the pulse form or pulse shape filter in accordance with a defined WTRU rule, wherein one or more WTRU rules are stored in the processor.

21. The WTRU of claim 16, wherein the signaling of the assignment message is performed through layer 2 or layer 3 messages.

22. The WTRU of claim 16, wherein the signaling of the assignment message is performed using non-access stratum (NAS) signaling messages.

23. The WTRU of claim 16, wherein the transmitter transmits the pulse capability indicator upon connection to a network.

24. The WTRU of claim 16, wherein the transmitter transmits the pulse capability indicator upon registering with a network.

25. The WTRU of claim 16, wherein the transmitter transmits the pulse capability indicator while communicating with a network equipment.
